(19) United States
(12) Patent Application Publication
(10) Pub. No.: US 2020/0287328 A1
(43) Pub. Date: Sep. 10, 2020

(54) ELECTRICAL CONNECTOR WITH FLEXIBLE BELLOWS

(71) Applicant: Aptiv Technologies Limited, St. Michael (BB)

(72) Inventors: Scott P. Cohen, Corona, CA (US); Mauri Jimenez, Tijuana (MX)

(21) Appl. No.: 16/292,427

(22) Filed: Mar. 5, 2019

(51) Int. Cl. H01R 13/64; H01R 13/52

(52) U.S. Cl. CPC H01R 13/64; H01R 13/5219

(57) ABSTRACT

An electrical connector assembly includes a connector body that is formed of a dielectric material. The electrical connector assembly defines a terminal cavity configured to receive an electrical terminal. The terminal cavity defines a terminal opening configured to receive a corresponding mating electrical terminal. The electrical connector assembly also includes a collapsible bellows that longitudinally surrounds the terminal opening. The bellows is integrally formed with the connector body. The connector body and the bellows are preferably integrally formed using an additive manufacturing process such as stereolithography, digital light processing, fused deposition modeling, fused filament fabrication, selective laser sintering, selecting heat sintering, multi-jet modeling, multi-jet fusion, electronic beam melting, laminated object manufacturing, or 3D printing.

### TECHNICAL FIELD OF THE INVENTION

The invention generally relates to an electrical connector, particularly an electrical connector with an integral flexible bellows.

### BRIEF DESCRIPTION OF THE SEVERAL VIEWS OF THE DRAWING

The present invention will now be described, by way of example with reference to the accompanying drawings, in which:

FIG. 1 is a perspective view of an electrical connector assembly, according to an embodiment of the invention;

FIG. 2 is an end view of the electrical connector assembly of FIG. 1, according to an embodiment of the invention; and

FIG. 3 is a cross section view of the electrical connector assembly of FIG. 1, according to an embodiment of the invention.

### DETAILED DESCRIPTION OF THE INVENTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Manufacturing processes have variations that affect a product's shape and dimensions. This implies no two parts are the same, making fitment a complex requirement when assembling parts, such as electrical connector assemblies, due to dimensional tolerances that need to be maintained. Especially with rigid materials, such as engineered plastics, there are often trade-offs between function and manufacturability.

A proposed innovative solution to the issues associated with dimensional tolerances can be provided by adding geometric compliance to a connector by replacing part of the connector body with a bellows or bellow-like feature. This flexible bellows can aid fitment to different geometries and sizes. Having a flexible bellows with the appropriate geometry can also lead to higher adaptability and provide varying levels of environmental sealing. Higher adaptability in the connector assembly can also lead to better performance regardless of some of the mating part's conditions. Utilizing additive manufacturing methods, the bellows can be integrally fabricated with the rest of the connector body. Conventional plastic molding technology cannot provide an economically viable means of producing such a product.

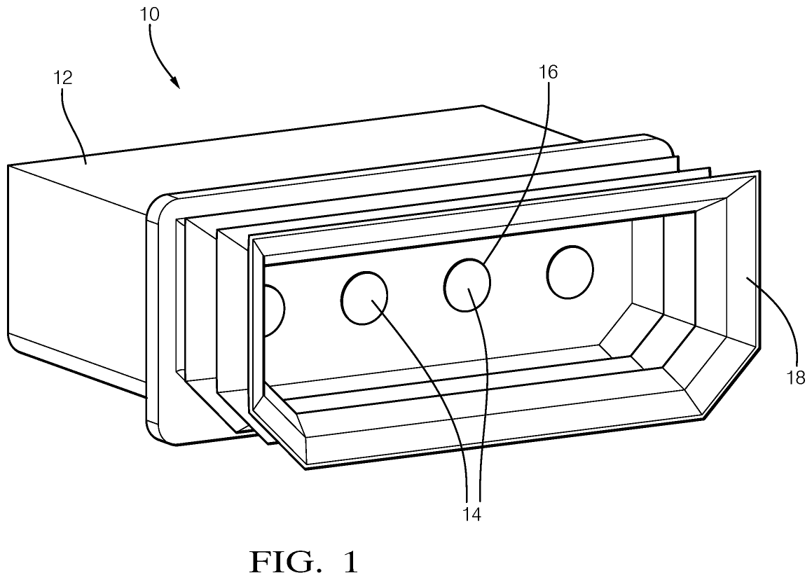

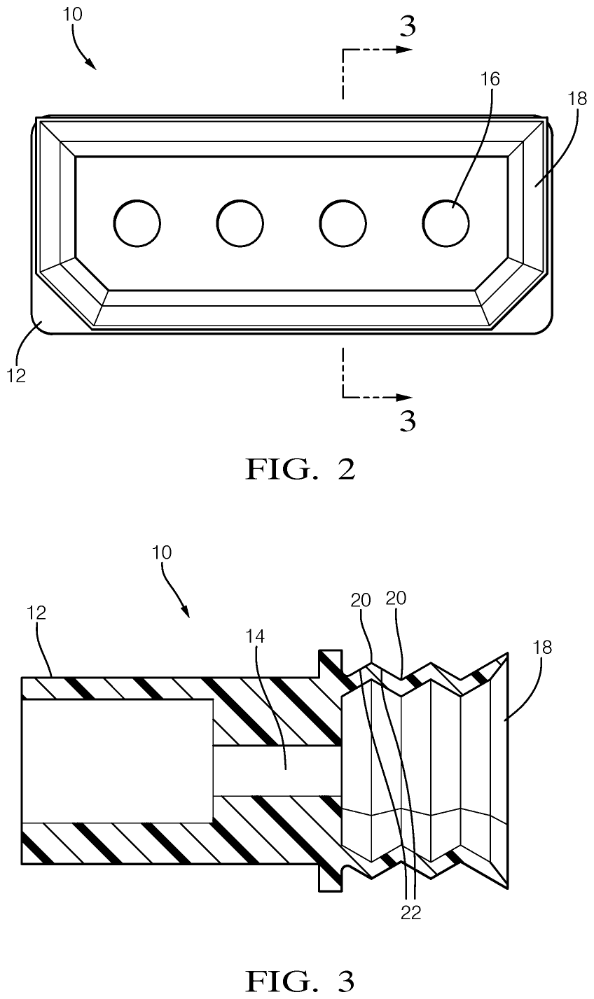

FIG. 1 illustrates an electrical connector assembly, hereinafter referred to as the assembly 10, according to an embodiment of this invention. The assembly 10 includes a connector body 12 that is formed of a polymeric dielectric material, such as polyamide (PA) or polybutylene terephthalate (PBT). The connector body 12 defines a plurality of terminal cavities 14 that extend longitudinally through the connector body 12. The terminal cavities 14 are each configured to receive and retain an electrical terminal (not shown). The electrical terminal may terminate a wire cable (not shown) or may be directly attached to a connective trace on a printed circuit board assembly (not shown). Each terminal cavity defines an opening 16 that is configured to receive a corresponding mating electrical terminal (not shown) therethrough. The assembly 10 also includes a collapsible bellows 18 that longitudinally surrounds the opening 16. This bellows 18 is integrally formed with the connector body 12. The bellows 18 is a folding bellows type that includes flexible linear hinge features 20 that are located intermediate less flexible planar web features 22. The bellows 18 is configured to contact a corresponding connector assembly (not shown) containing the corresponding mating terminals. As the bellows 18 contacts the corresponding connector assembly, the hinge features 20 bend, thereby allowing the bellows 18 to compress as the assembly 10 is mated with the corresponding connector assembly. The compression of the bellows 18 allows for larger dimensional tolerance between the assembly 10 and the corresponding connector assembly. The bellows 18 may also provide protection of the terminal interface from environmental contaminants, such as dust or water, by inhibiting the intrusion of these contaminants into the terminal cavities 14. The assembly 10 should have an ingress protection rating according to International Electrotechnical Commission (IEC) Standard 60529 of at least IP50 and could have an IP rating up to IP52 depending on the particular application in which the assembly 10 is used.

The connector body 12 and the bellows 18 of the illustrated embodiment are integrally formed using an additive manufacturing process, such as stereolithography, digital light processing, fused deposition modeling, fused filament fabrication, selective laser sintering, selecting heat sintering, multi-jet modeling, multi-jet fusion, electronic beam melting, laminated object manufacturing, or 3D printing.

According to the embodiment illustrated in FIG. 3, the bellows 18 is formed of the same polymeric dielectric material as the connector body 12.

While the illustrated embodiment presented herein includes a folding bellows feature, the bellows may alternatively be configured as a corrugated bellows feature. Additionally, while the illustrated embodiment is directed to an electrical connector assembly, other embodiments may be envisioned that are adapted for use with other types of connector assemblies for fiber optic cables, pneumatic tubes, hydraulic tubes, or a hybrid connector assembly including two or more of the items listed above.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments, and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. (canceled)

2. An electrical connector assembly, comprising:
an electrical terminal;
a connector body formed of a dielectric material defining a terminal cavity in which the electrical terminal is disposed, said terminal cavity defining an opening configured to receive a corresponding mating electrical terminal; and
a collapsible bellows longitudinally surrounding the opening and integrally formed with the connector body, wherein the bellows has flexible linear hinges intermediate planar trapezoidal-shaped web features.

3. The electrical connector assembly according to claim 2, wherein the additive manufacturing process is selected from a list consisting of stereolithography, digital light processing, fused deposition modeling, fused filament fabrication, selective laser sintering, selecting heat sintering, multi-jet modeling, multi-jet fusion, electronic beam melting, laminated object manufacturing, and 3D printing.

4. (canceled)

5. The electrical connector assembly according to claim 2, wherein the bellows is formed of the same dielectric material as the connector body.

6.-9. (canceled)
